(19) United States
(12) Patent Application Publication
(10) Pub. No.: US 2015/0311620 A1
(43) Pub. Date: Oct. 29, 2015

(54) ELECTRICAL CONNECTOR

(71) Applicant: Dai-ichi Seiko Co, Ltd., Kyoto-shi (JP)

(72) Inventors: Jin Tateishi, Ogori-shi (JP); Yuki Nakamura, Ogori-shi (JP)

(21) Appl. No.: 14/684,849

(22) Filed: Apr. 13, 2015

(30) Foreign Application Priority Data
Apr. 23, 2014 (JP) 2014-089092

(51) Int. Cl. H01R 13/46

(52) U.S. Cl. CPC H01R 13/46

(57) ABSTRACT

An actuator includes a tabular partition that partitions, for each beam located at a position that allows the beam to abut the actuator, a through-hole into which one of a pair of beams located at the other-end side and at the position that allows the beam to abut the actuator is inserted to prevent the beam from abutting the actuator, and a wider-width part including a wider-width surface which is disposed at one end of the partition corresponding to an upstream side of a flow of resin flowed to mold the partition when the actuator is molded by the resin containing a filler, and which has a wider width than a width of the one end of the partition.

### CROSS-REFERENCE TO RELATED APPLICATION

This application claims the benefit of Japanese Patent Application No. 2014-089092, filed Apr. 23, 2014, the entire disclosure of which is incorporated by reference herein.

### FIELD

This application relates generally to an electrical connector.

### BACKGROUND

Electrical connectors are known which have signal transmission members typified by FPCs (Flexible Printed Circuits) and fitted in a slot of an insulative housing that constructs the connector to electrically connect a substrate on which the connector is mounted with the electrodes of the signal transmission member.

According to this type of electrical connectors, in general, an actuator provided with an operation lever to be operated by a user is attached to the housing in a freely rotatable manner. When the actuator is rotated so as to be substantially parallel to the fitting direction of the signal transmission member by the user operation given to the operation lever, the end portions of contacts located in the slot of the housing come close to the electrodes of the signal transmission member, and thus each contact and each electrode contact with each other.

This type of actuator is formed with through-holes through which the respective contacts located at a position that allows the contact to abut the actuator are inserted to prevent that contact from abutting the actuator.

Those through-holes are partitioned from the adjoining through-hole by a tabular partition that has one end coupled with the operation lever.

### CITATION LIST

### Patent Literature

[Patent Literature 1] Unexamined Japanese Patent Application Kokai Publication No. 2008-108458.

### SUMMARY

The Patent Literature 1 discloses electrical connectors and the like which have the advancement in reduction of the disposing pitch of the contacts (narrow pitching) in accordance with a request for downsizing. According to this reduction, the width of the partition in the direction in which the contacts are disposed side by side is also reduced.

In this case, when the width of the partition decreases, the rigidity of the partition decreases. Hence, due to shock by, for example, falling of the electrical connector, the partition is likely to be chipped or bent.

In view of such a circumstance, when a resin is filled in a die to integrally mold the actuator, it is necessary to apply a resin that has high rigidity. Hence, the filler contained in the resin tends to be long.

When, however, the width of the partition decreases, the area of the coupling part between the partition and the major body of the operation lever becomes small. Hence, when the filler to be contained in the resin is long, the filler is likely to remain at a coupling portion in the die between a portion where the partition is to be molded and a portion where the operation lever is to be molded. Consequently, the filler is not likely to flow in the portion where the partition is to be molded.

Accordingly, when the filler contained in the resin is long, according to the shape of the actuator disclosed in the Patent Literature 1, the partition that has insufficient rigidity is to be formed.

The present disclosure has been made in view of the aforementioned circumstances, and it is an objective of the present disclosure to provide an electrical connector that includes a partition with sufficient rigidity.

### Solution to Problem

To accomplish the above objective, an electrical connector according to an aspect of the present disclosure includes:

an insulative housing that is formed with a slot in which a tabular signal transmission member is fittable;

a plurality of contacts each including an elastic conductor in a substantially H shape including a pair of beams and a pillar that connects the pair of beams with each other, the pair of beams located at one-end side with reference to the pillar being disposed in the slot of the housing so as to correspond to respective electrodes of the signal transmission member fitted in the housing through the slot; and

an actuator attached to the housing in a freely rotatable manner, including a shaft which is held between the pair of beams at an other-end side with reference to the pillar, and which is rotatable around an axial center along with the rotation of the actuator, and enabling the plurality of contacts to contact the electrodes upon rotation of the shaft,

in which the actuator comprises:
a tabular partition that partitions, for each beam located at a position that allows the beam to abut the actuator, a through-hole into which one of the pair of beams located at the other-end side and at the position that allows the beam to abut the actuator is inserted to prevent the beam from abutting the actuator; and

a wider-width part including a wider-width surface which is disposed at one end of the partition corresponding to an upstream side of a flow of resin flowed to mold the partition when the actuator is molded by the resin containing a filler, and which has a wider width than a width of the one end of the partition.

The actuator may further include an operation part to be rotated;

the one end of the partition may be connected with the operation part; and the wider-width part may be disposed between the operation part corresponding to the upstream side of the resin flow and the one end of the partition.

The one end of the partition may be connected with the shaft; and

the wider-width part may be disposed between the shaft corresponding to the upstream side of the resin flow and the one end of the partition.

Among contour lines of the wider-width surface, two lines that couple the upstream side of the resin flow with the downstream side thereof may be straight lines that increase the width of the wider-width surface toward the upstream side from the downstream side.

Among contour lines of the wider-width surface, two lines that couple the upstream side of the resin flow with the downstream side thereof may be curved lines that increase the width of the wider-width surface toward the upstream side from the downstream side.

A maximum width of the wider-width surface may be greater than a length of the filler contained in the resin that molds the actuator.

According to the present disclosure, the wider-width part including a wider-width surface with a larger width than the width of one of the partition is disposed at the one end of the partition corresponding to the upstream side of the resin flow that is flowed to mold the partition. The wider-width part has a function of, when the actuator is molded by the resin containing a filler, guiding the filler contained in the resin to the one end of the partition, and of facilitating the filler to flow in the partition. Hence, according to the present disclosure, the partition can have sufficient rigidity.

### BRIEF DESCRIPTION OF THE DRAWINGS

A more complete understanding of this application can be obtained when the following detailed description is considered in conjunction with the following drawings, in which:

FIG. 1 is a perspective view when an actuator of an electrical connector according to a first embodiment of the present disclosure is in a free condition;

FIG. 2 is a top view when the actuator of the electrical connector of the present disclosure is in a free condition;

FIG. 3 is a cross-sectional view of the electrical connector along a line A-A in FIG. 2;

FIG. 4 is a cross-sectional view of the electrical connector along a line B-B in FIG. 2;

FIG. 5 is a perspective view when the actuator of the electrical connector of the present disclosure is in a locked condition;

FIG. 6 is a top view when the actuator of the electrical connector of the present disclosure is in a locked condition;

FIG. 7 is a cross-sectional view of the electrical connector along a line C-C in FIG. 6;

FIG. 8 is a cross-sectional view of the electrical connector along a line D-D in FIG. 6;

FIG. 9A is a perspective view of the actuator according to the first embodiment of the present disclosure;

FIG. 9B is a top view of the actuator according to the first embodiment of the present disclosure;

FIG. 10A is a schematic diagram of a die that integrally molds the actuator according to the first embodiment of the present disclosure;

FIG. 10B is a (first) diagram illustrating how a resin flows in the die illustrated in the schematic diagram of FIG. 10A step by step;

FIG. 10C is a (second) diagram illustrating how the resin flows in the die illustrated in the schematic diagram of FIG. 10A step by step;

FIG. 10D is a (third) diagram illustrating how the resin flows in the die illustrated in the schematic diagram of FIG. 10A step by step;

FIG. 11A is a perspective view of an actuator according to a second embodiment of the present disclosure; and

FIG. 11B is a top view of the actuator according to the second embodiment of the present disclosure.

### DETAILED DESCRIPTION

### First Embodiment

An explanation will be given of an electrical connector 10 according to a first embodiment of the present disclosure. In respective accompanying figures, the shorter-side direction of the electrical connector 10 is defined as an x-axis direction, the longer-side direction is defined as a y-axis direction, and the thickness direction is defined as a z-axis direction to set an orthogonal coordinate system, and this coordinate system will be referred as needed. In addition, the direction of an arrow in each axis is expressed by a symbol + (plus), while the opposite direction is expressed by a symbol − (minus).

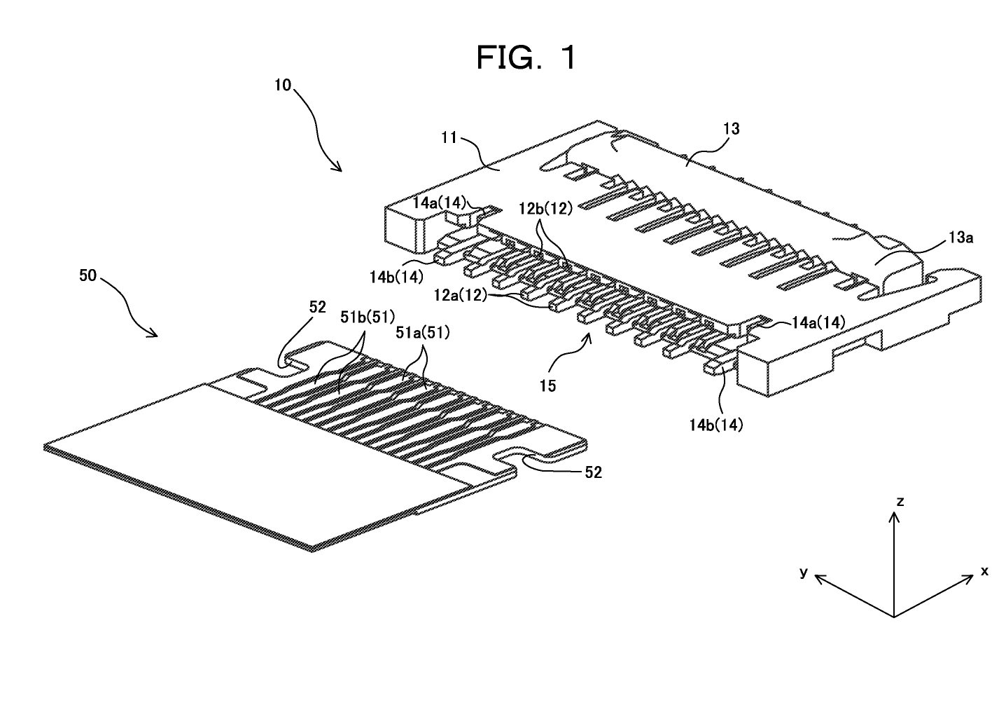

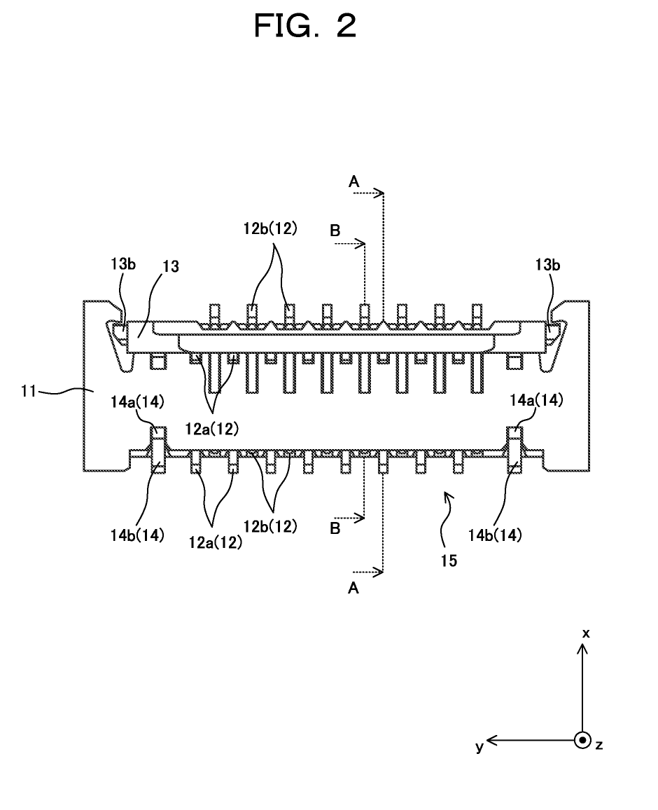

As illustrated in FIGS. 1 and 2, the electrical connector 10 includes a rectangular housing 11, contacts 12 disposed in the housing 11, an actuator 13 attached to the housing 11 in a freely rotatable manner, and lockings 14 disposed in the housing 11.

The housing 11 is formed of an insulative material like a resin, and is disposed on, for example, a wiring board of an electronic device. The housing 11 is formed with a slot 15 in which an FPC 50 that is an example tabular signal transmission member is fittable. The opening of the slot 15 is wide at the front side, and is narrow at the back side.

The FPC 50 fitted in the housing 11 through the slot 15 is not fastened with the housing 11 when the actuator 13 is substantially vertical (free condition) to the fitting direction of the FPC 50, and thus the FPC 50 is tentatively retained in the housing 11 in this condition. At this time, a user can detach the FPC 50 from the housing 11 (can move the FPC 50 in the −x direction).

When the actuator 13 becomes substantially parallel (locked condition) to the fitting direction of the FPC 50 and the lockings 14 restrict the movement of the FPC 50 in the −x direction, the FPC 50 is eventually retained in the housing 11.

The FPC 50 includes electrodes 51. The electrodes 51 include two kinds of electrodes that are first electrodes 51a and second electrodes 51b. The first electrodes 51a are provided at one-end side of the FPC 50. The second electrodes 51b are provided so as to be apart from the one-end side of the FPC 50. In addition, the FPC 50 is formed with cut-outs 52 to be caught by the respective lockings 14.

The contacts 12 are each an elastic conductor like a metal. The contacts 12 include two kinds of contacts that are first contacts 12a and second contacts 12b. The first contacts 12a are disposed at locations corresponding to the first electrodes 51a of the FPC 50 fitted in the housing 11. The second contacts 12b are disposed at locations correspond to the second electrodes 51b of the FPC 50 fitted in the housing 11. Those contacts 12a, 12b are fastened to the housing 11.

The first contacts 12a and the second contacts 12b are alternately disposed in the longer-side direction (y-axis direction) of the housing 11.

The actuator 13 is disposed at the back side (opposite side to the slot 15) of the housing 11. The actuator 13 includes an operation part 13a that extends along the longer-side direction (y-axis direction) of the housing 11, and, as illustrated in FIG. 2, abutting parts 13b disposed at both ends of the operation part 13a in the longer-side direction. The longer-side direction of the operation part 13a is substantially parallel to the longer-side direction of the housing 11.

The abutting parts 13b are retained in respective recesses provided in the housing 11, and are attached in a freely rotatable manner relative to the housing 11. Hence, the user (operator) can rotate the actuator 13 by rotating the operation part 13a.

Next, a detailed explanation will be given of the above-explained first contacts 12a, second contacts 12b, and actuator 13.

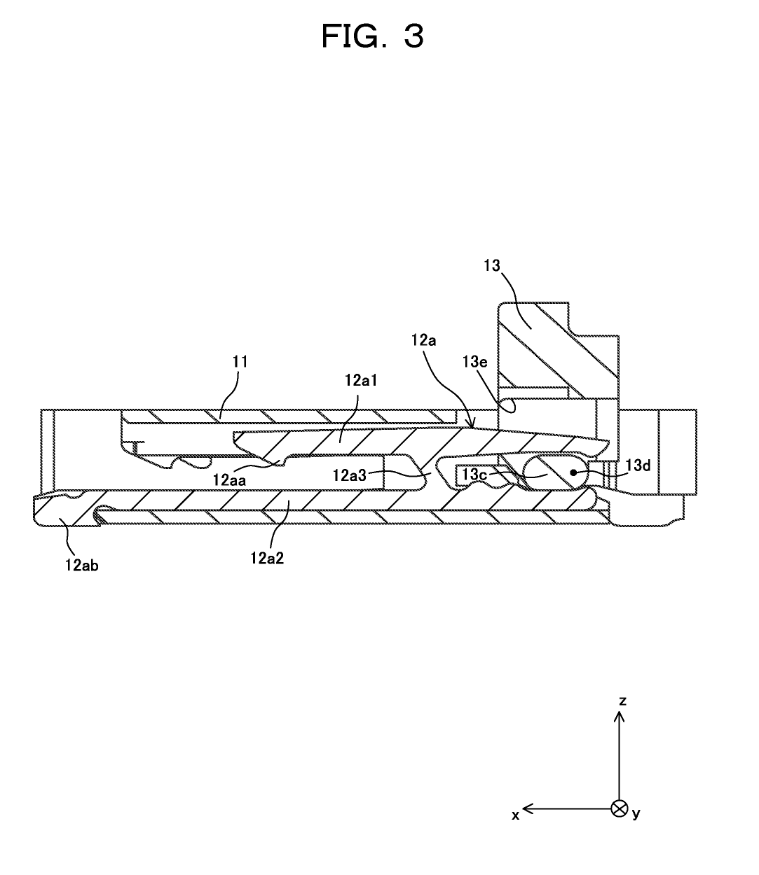

As illustrated in FIG. 3 (a cross-sectional view along a line A-A in FIG. 2), the first contacts 12a each include a pair of beams 12a1, 12a2 (an upper beam 12a1, and a lower beam 12a2 that is longer than the upper beam 12a1). In addition, the first contacts 12a each include a pillar 12a3 that connects the upper beam 12a1 with the lower beam 12a2. The first contacts 12a are each in a substantially H shape.

The pair of beams (upper beam 12a1 and lower beam 12a2) located at the one-end side of the first contact 12a with reference to the pillar 12a3 is disposed and exposed in the slot 15 of the housing 11. Between the pair of beams located at the one-end side of the first contact 12a (slot-15 side with reference to the pillar 12a3), the upper beam 12a1 has an end portion provided with a first contact part 12aa that can abut the first electrode 51a. In addition, between the pair of beams located at the one-end side of the first contact 12a, the lower beam 12a2 has an end portion provided with a first connection part 12ab to be soldered to, for example, the electrode of the wiring board of an electronic device.

Still further, the pair of beams (upper beam 12a1 and lower beam 12a2) located at the other-end side of the first contact 12a with reference to the pillar 12a3 (back side of the housing 11 with reference to the pillar 12a3) are exposed at the back side of the housing 11.

Held between the pair of beams (upper beam 12a1 and lower beam 12a2) at the other-end side of the first contact 12a is a shaft 13c of the actuator 13. The shaft 13c is rotatable around an axial center 13d along with the rotation of the actuator 13. The shaft 13c has an elliptical cross-section.

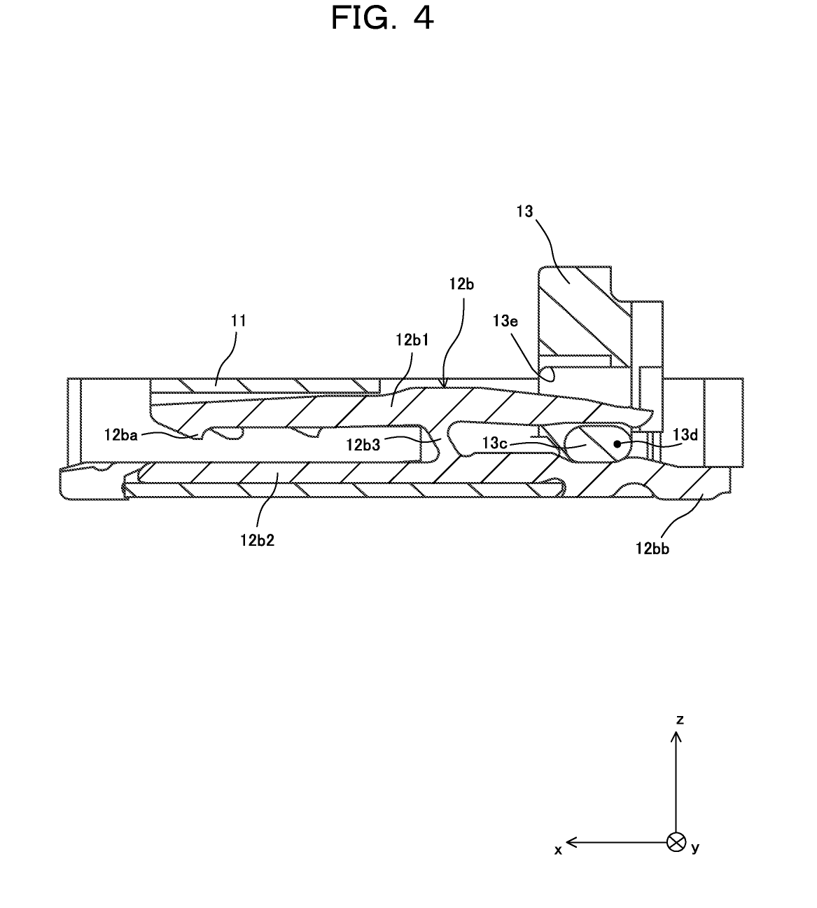

As illustrated in FIG. 4 (a cross-sectional view along a line B-B in FIG. 2), the shaft 13c is also held by the second contacts 12b.

The second contacts 12b each include a pair of beams 12b1, 12b2 (upper beam 12b1 and lower beam 12b2 that is longer than upper beam 12b1). In addition, the second contacts 12b each include a pillar 12b3 that connects the upper beam 12b1 with the lower beam 12b2. The second contacts 12b are each in a substantially H shape.

The pair of beams (upper beam 12b1 and lower beam 12b2) located at the one-end side of the second contact 12b with reference to the pillar 12b3 is disposed and exposed in the slot 15 of the housing 11. Between the pair of beams located at the one-end side of the second contact 12b, the upper beam 12b1 has an end portion provided with a second contact part 12ba that can abut the second electrode 51b.

Still further, the pair of beams (upper beam 12b1 and lower beam 12b2) located at the other-end side of the second contact 12b with reference to the pillar 12b3 (back side of the housing 11) are exposed at the back side of the housing 11. The shaft 13c of the actuator 13 is held between the pair of beams (upper beam 12b1 and lower beam 12b2). In addition, between the pair of beams located at the other-end side of the second contact 12b, the lower beam 12b2 has an end portion provided with a second connection part 12bb to be soldered to, for example, the electrode of the wiring board of an electronic device.

When the actuator 13 is in a free condition, the pair of beams (upper beam 12b1 and lower beam 12b2) at the other-end side of the second contact 12b (back side of the housing 11), and the pair of beams (upper beam 12a1 and lower beam 12a2) located at the other-end side of the first contact 12a are in a condition holding therebetween two points of the shaft 13c that form shorter sides thereof in the cross-sectional surface.

Hence, the gap between the pair of beams at the one-end side of the second contact 12b (slot-15 side), and the gap between the pair of beams at the one-end side of the first contact 12a become wider than those of the locked condition. Accordingly, the second contact part 12ba and the second electrode 51b, and, the first contact part 12aa and the first electrode 51a are in a non-contact condition or in a slightly contacting condition.

Still further, the shaft 13c can contact the lockings 14 illustrated in FIGS. 1 and 2. The lockings 14 each include, like the first and second contacts 12a, 12b, a pair of beams 14a, 14b (upper beam 14a and lower beam 14b that is longer than upper beam 14a). In addition, the lockings 14 each include a pillar (unillustrated) that connects the upper beam 14a with the lower beam 14b. The lockings 14 are each in a substantially H shape like the first and second contacts 12a, 12b.

The pair of beams located at the one-end side (slot-15 side) of the locking 14 with reference to the pillar is disposed and exposed in the slot 15 of the housing 11. Between the pair of beams located at the one-end side of the locking 14 with reference to the pillar, the upper beam 14a has an end portion provided with a pawl (unillustrated) that is a protrusion to be engaged with the cut-out 52 of the FPC 50.

Still further, the shaft 13c of the actuator 13 is disposed between the pair of beams (upper beam 14a and lower beam 14b) at the other-end side of the locking 14 with reference to the pillar (back side of the housing 11).

When, for example, as illustrated in FIGS. 3 and 4, the actuator 13 is in a free condition, the pair of beams (upper beam 14a and lower beam 14b) at the other-end side of the locking 14 (back side of the housing 11) is in a condition holding therebetween the two points of the shaft 13c that form the shorter sides thereof in the cross-sectional surface.

Hence, the gap between the pair of beams (upper beam 14a and lower beam 14b) at the one-end side of the locking 14 (slot-15 side) becomes wider than that of the locked condition. Accordingly, the user can fit the FPC 50 in the slot 15 of the housing 11, and tentatively retains the FPC 50 in the housing 11.

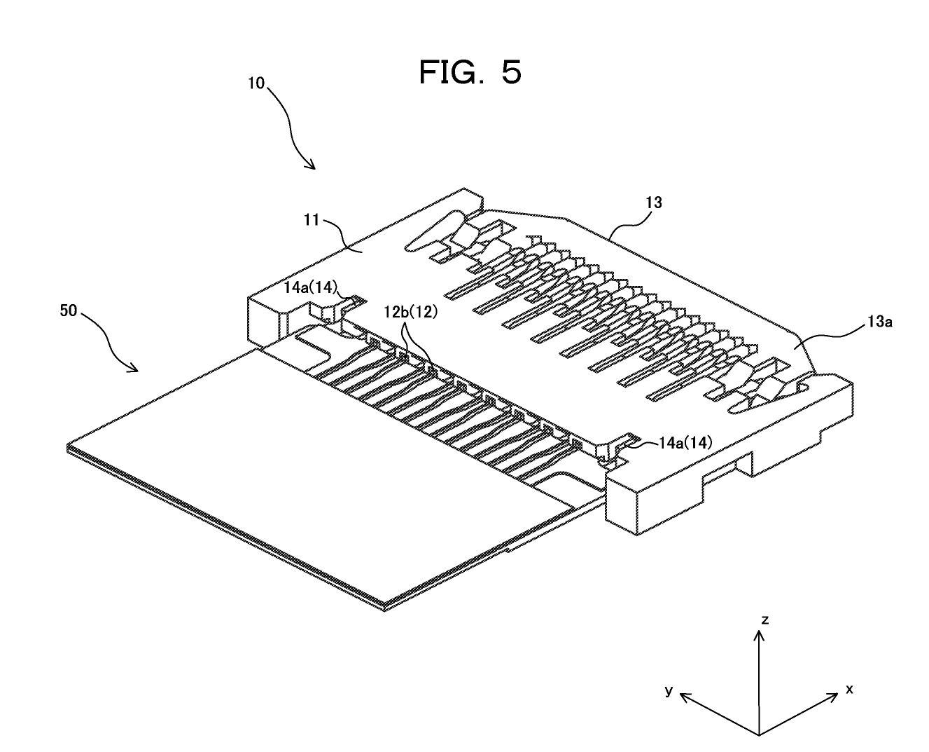

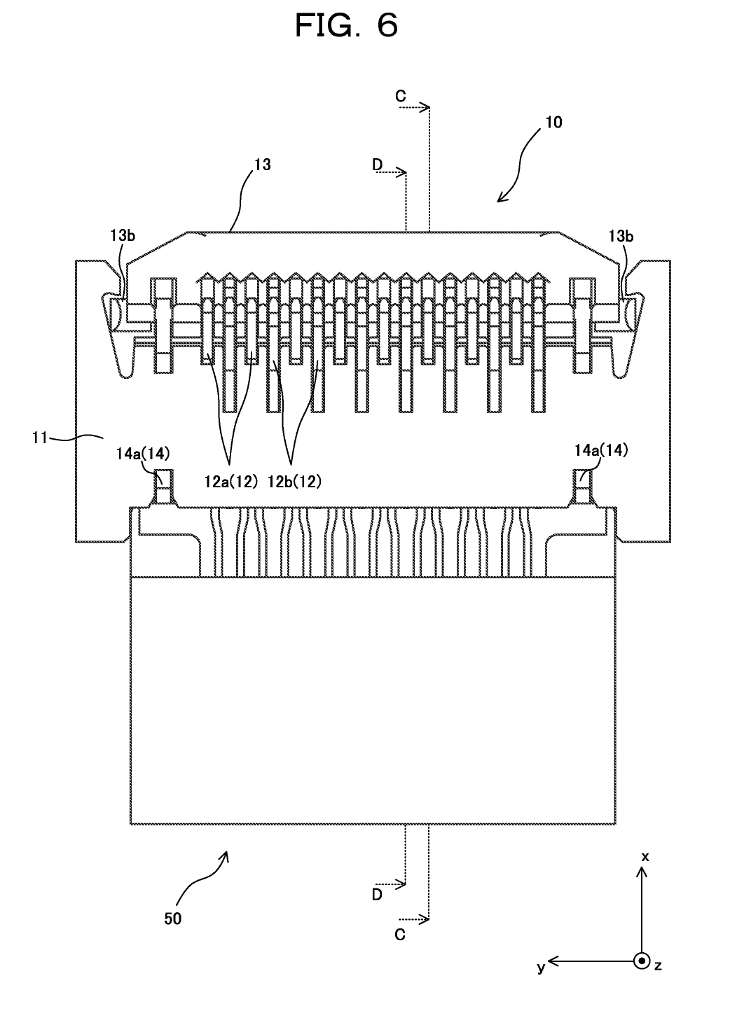

When the operator rotates the actuator 13 that is in a free condition, as illustrated in FIGS. 5 and 6, the actuator 13 becomes a locked condition (substantially horizontal to the fitting direction of the FPC 50). While the actuator 13 is being rotated from the free condition to the locked condition, the shaft 13c of the actuator 13 rotates around the axial center 13d.

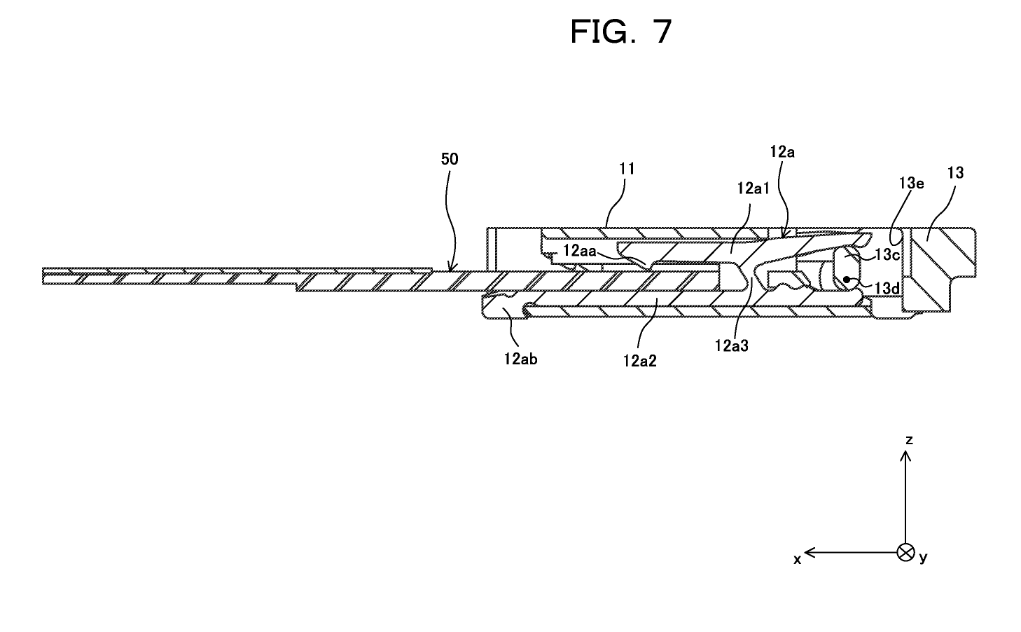

When the actuator 13 is in a locked condition, as illustrated in FIG. 7 (a cross-sectional view along a line C-C in FIG. 6), the pair of beams (upper beam 12a1 and lower beam 12a2) located at the other-end side of the first contact 12a is in a condition holding therebetween the two points of the shaft 13c that form the longer sides thereof in the cross-sectional surface.

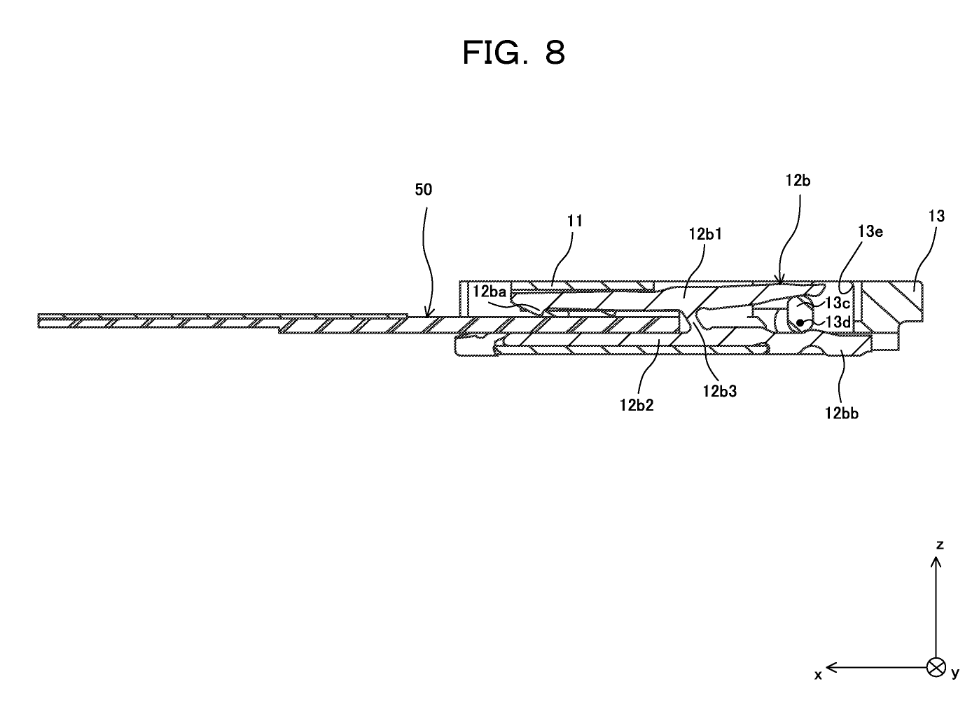

Likewise, when the actuator 13 is in a locked condition, as illustrated in FIG. 8 (a cross-sectional view along a line D-D in FIG. 6), the pair of beams (upper beam 12b1 and lower beam 12b2) located at the other-end side of the second contact 12b is in a condition holding therebetween the two points of the shaft 13c that form the longer sides thereof in the cross-sectional surface.

At this time, the gap between the pair of beams at the one-end side of the first contact 12a (slot-15 side), and the gap between the pair of beams at the one-end side of the second contact 12b are narrower than those of the free condition as illustrated in FIGS. 7 and 8. Hence, the first contact part 12aa and the first electrode 51a, and, the second contact part 12ba and the second electrode 51b become a contacting condition.

In addition, when the actuator 13 becomes a locked condition, the pair of beams (upper beam 14a and lower beam 14b) located at the other-end side of the locking 14 (back side of the housing 11) becomes a condition holding therebetween the two points of the shaft 13c that form the longer sides thereof in the cross-sectional surface.

At this time, the gap between the pair of beams at the one-end side of the locking 14 (slot-15 side) becomes narrower than that of the free condition. Hence, the pawl of the upper beam 14a located at the one-end side of the locking 14 catches the cut-out 52. Accordingly, the movement of the FPC 50 in the attaching/detaching direction that is −x direction is restricted, and thus the FPC 50 is eventually retained in the housing 11.

In this case, as illustrated in, for example, FIGS. 3, 4, 7 and 8, the upper beam 12a1 located at the other-end side of the first contact 12a (back side of the housing 11), and the upper beam 12b1 located at the other-end side of the second contact 12b are located at positions that allow the respective beams to abut the actuator 13.

Hence, the actuator 13 is formed with through-holes 13e in which the respective upper beams 12a1 located at the other-end side of the first contact 12a (back side of housing 11) and the respective upper beams 12b1 located at the other-end side of the second contact 12b are fitted so as to prevent those upper beams 12a1, 12b1 from abutting the actuator 13.

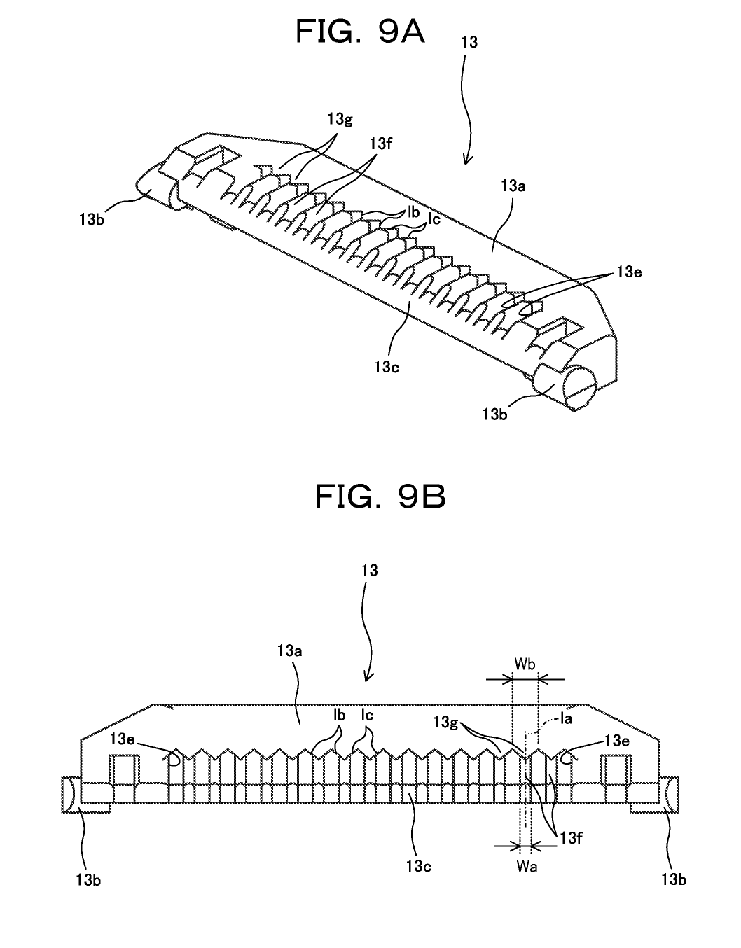

As illustrated in FIGS. 9A and 9B, those through-hole 13e are partitioned by tabular partitions 13f each of which has one end connected to the operation part 13a, and also has the other end connected with the shaft 13c in order to suppress a reduction of the whole rigidity of the actuator 13 due to the formation of the through-holes 13e.

More specifically, the through-holes 13e are partitioned by the partitions 13f for each upper beam 12a1 located at the other-end side of the first contacts 12a and for each upper beam 12b1 located at the other-end side of the second contact 12b (for each beam disposed at a location that allows the beam to abut the actuator 13).

Disposed between the one end of the partition 13f and the operation part 13a is a wider-width part 13g that includes a wider-width surface with a wider width Wb than a width Wa of the one end of the partition 13f. In addition, among the contour lines of the wider-width surface of the wider-width part 13g, two lines 1b, 1c that couple the one end of the partition 13f with the operation part 13a are symmetrical straight lines with reference to a bisector 1a of the partition 13f. The width (gap) between the two straight lines 1b, 1c becomes wide toward the operation part 13a from the one end of the partition 13f, and thus the width of the wider-width surface increases.

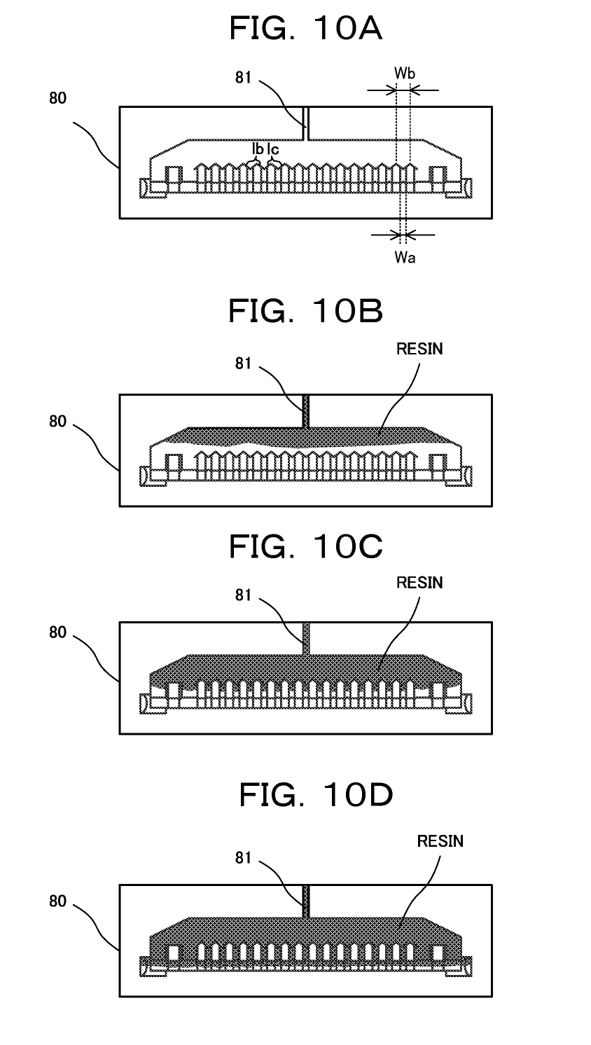

As illustrated in FIG. 10A, the wider-width part 13g including the wider-width surface functions as follow when a resin containing a filler is filled in a die 80 that has the shape of the actuator 13 to integrally mold the actuator 13.

When the resin is flowed into an inlet 81 of the die 80, as illustrated in FIG. 10B, first, the resin flows in a portion where the operation part 13a is to be molded. Next, the resin that has flowed through the portion where the operation part 13a is to be molded flows in a portion where the respective wider-width parts 13g are to be molded as illustrated in FIG. 10C, and further flows in the portion where the respective partitions 13f are to be molded.

In this case, the portion of the die 80 where the respective wider-width parts 13g are to be molded is located at the upstream side in the flow of the resin relative to the portion where the respective partitions 13f are to be molded. In addition, the maximum width Wb of the portion of the die 80 where the wider-width surface of the wider-width part 13g is to be molded is greater than the length of the filler contained in the resin. Still further, among the contour lines of the wider-width surface of the portion where the wider-width part 13g is to be molded, the gap between the two straight lines 1b, 1c that couple the upstream side of the resin flow with the downstream side thereof becomes wide toward the upstream side from the downstream side, and the width of the wider-width surface increases.

Accordingly, the portion where the wider-width surface of the wider-width part 13g is to be molded can guide, to the portion where the partition 13f is to be molded, the filler contained in the resin flowing into the portion where the partition 13f is to be molded. The portion where the wider-width surface of the wider-width part 13g is to be molded can adjust the direction of the filler flowing into the portion where the partition 13f is to be molded.

Accordingly, the portion where the wider-width surface of the wider-width part 13g is to be molded prevents the filler from remaining at the coupling portion between the portion where the partition 13f is to be molded and the portion where the operation part 13a is to be molded, allowing the filler to easily flow into the portion where the partition 13f is to be molded.

Therefore, as illustrated in FIG. 10D, a sufficient filler can flow in the portion where the partition 13f is to be molded together with the resin. This enables the partition 13f to have sufficient rigidity.

Since the actuator 13 is integrally molded in this manner, as illustrated in FIGS. 9A and 9B, the actuator 13 is formed with the wider-width parts 13g at the respective one ends of the partitions 13f coupled with the operation part 13a. That is, the wider-width parts 13g are formed each of which has the maximum width greater than the length of the filler, and each of which has the width of wider-width surface increasing since the gap between the two straight lines 1b, 1c that couple the upstream side of the resin flow with the downstream side thereof among the contour lines of the wider-width surface increases toward the upstream side from the downstream side.

As explained above, according to the electrical connector 10 of the first embodiment, the wider-width parts 13g are disposed at the respective one ends of the partitions 13f corresponding to the upstream side of the resin flow to mold the respective partitions 13f. Hence, according to the electrical connector 10 of the first embodiment, the partitions 13f can have sufficient rigidity.

### Second Embodiment

According to the above-explained electrical connector 10 of the first embodiment, the two lines 1b, 1c that couple the one end of the partition 13f with the operation part 13a to realize a width which becomes wide toward the upstream side of the resin flow from the downstream side thereof are both straight lines.

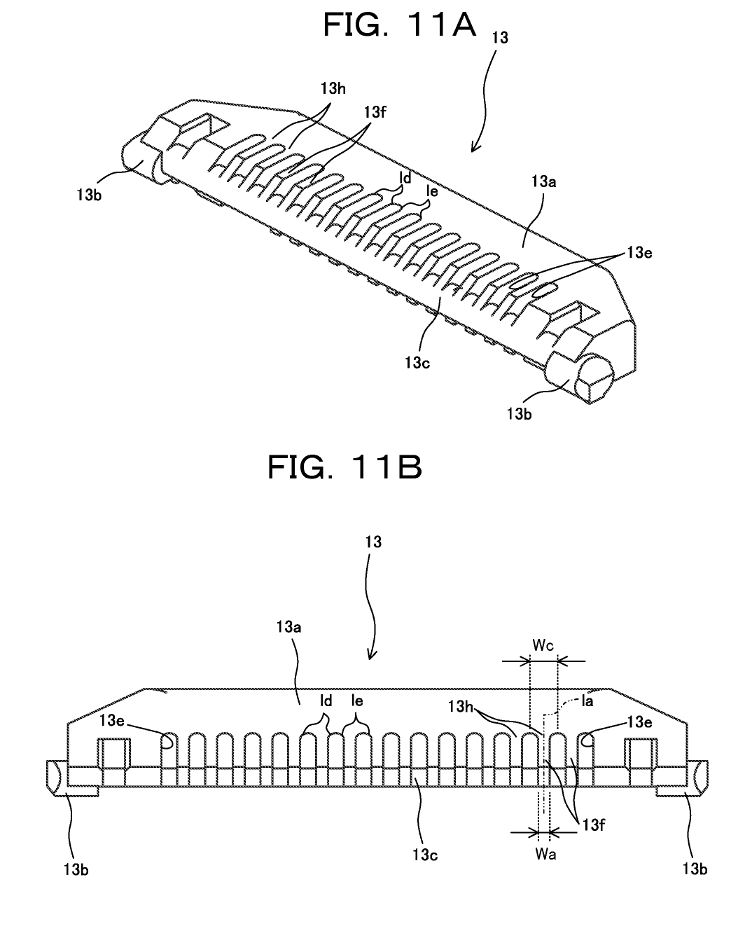

Instead of this structure, according to the electrical connector 10 of the second embodiment, as illustrated in FIGS. 11A and 11B, two lines 1d, 1e that couple the one end of the partition 13f with the operation part 13a are both curved lines that increase a gap toward the upstream side of the resin flow from the downstream side thereof.

The other structures of the electrical connector 10 of the second embodiment are the same as those of the electrical connector 10 of the first embodiment.

Disposed between the one end of the partition 13f and the operation part 13a is a wider-width part 13h that has a wider-width surface with a width Wc which is larger than the width Wa of the one end of the partition 13f. The maximum width Wc of the wider-width part 13h is greater than the length of the filler contained in the resin.

In addition, among the contour lines of the wider-width surface of the wider-width part 13h, the two curved lines 1d, 1e that couple the one end of the partition 13f with the operation part 13a are symmetrical curved lines with reference to the bisector 1a of the partition 13f, and the gaps of the two curved lines become wide toward the operation part 13a from the one end of the partition 13f.

The resin filled in the inlet of the die first flows in a portion where the operation part 13a is to be molded, flows in a portion where the respective wider-width parts 13h are to be molded, and flows in a portion where the respective partitions 13f are to be molded. When the actuator 13 is integrally molded using a die that forms such a resin flow, the portion where the respective wider-width parts 13h are to be molded is located at the upstream side in the resin flow relative to the portion where the respective partitions 13f are to be molded.

In addition, in this die, the maximum width Wc of the portion where the wider-width surface of the wider-width part 13h is to be molded is greater than the length of the filler contained in the resin. Still further, among the contour lines of the wider-width surface of the portion where the wider-width part 13h is to be molded, the two lines 1d, 1e that couple the upstream side of the resin flow with the downstream side thereof have the respective gaps increasing toward the upstream side from the downstream side.

Accordingly, in the die for integrally molding the actuator 13, the portion where the wider-width surface of the wider-width part 13h is to be molded can guide, to the portion where the partition 13f is to be molded, the filler contained in the resin flowing into the portion where the partition 13f is to be molded. The portion where the wider-width surface of the wider-width part 13h is to be molded can adjust the direction of the filler flowing into the portion where the partition 13f is to be molded.

Accordingly, the portion where the wider-width surface of the wider-width part 13h is to be molded prevents the filler from remaining at the coupling portion between the portion where the partition 13f is to be molded and the portion where the operation part 13a is to be molded, allowing the filler to easily flow into the portion where the partition 13f is to be molded.

Therefore, a sufficient filler can flow in the portion where the partition 13f is to be molded together with the resin. This enables the partition 13f to have sufficient rigidity.

As explained above, according to the electrical connector 10 of the second embodiment, the wider-width parts 13h are provided each of which includes the two curved lines that couple the downstream side of the resin flow with the upstream side thereof. In the wider-width part 13h, the gap increases toward the upstream side of the resin flow from the downstream side thereof. Hence, a sufficient filler can be filled in the portion where the partition 13f is to be molded. Therefore, according to the electrical connector 10 of the second embodiment, the partition 13f can have sufficient rigidity.

Although the embodiments of the present disclosure were explained above, the present disclosure is not limited to the aforementioned embodiments, and various modifications and changes can be made thereto.

For example, according to the above-explained electrical connector 10 of the first embodiment, among the contour lines of the wider-width surface of the wider-width part 13g, the two straight lines 1b, 1c that couple the upstream side of the resin flow with the downstream side thereof (that couple the operation part 13a with the one end of the partition 13f) are symmetrical straight lines with reference to the bisector 1a of the partition 13f.

However, the present disclosure is not limited to this structure. The two straight lines 1b, 1c that couple the operation part 13a with the one end of the partition 13f may increase the width of the wider-width surface of the wider-width part 13g toward the operation part 13a from the one end of the partition 13f.

Hence, in the electrical connector 10, for example, either one of the two straight lines 1b, 1c that couple the one end of the partition 13f with the operation part 13a may not be in parallel with the bisector 1a of the partition 13f like the electrical connector 10 of the first embodiment, and the other straight line may be in parallel with the bisector 1a of the partition 13f.

Likewise, according to the above-explained electrical connector 10 of the second embodiment, among the contour lines of the wider-width surface of the wider-width part 13h, the two curved lines 1d, 1e that couple the upstream side of the resin flow with the downstream side thereof (that couple the operation part 13a with the one end of the partition 13f) are symmetrical curved lines with reference to the bisector 1a of the partition 13f.

However, the present disclosure is not limited to this structure. The two curved lines that couple the operation part 13a with the one end of the partition 13f may increase the width of the wider-width surface of the wider-width part 13h toward the operation part 13a from the one end of the partition 13f.

Hence, in the electrical connector 10, for example, either one of the two lines that couple the one end of the partition 13f with the operation part 13a may be a curved line like the electrical connector 10 of the second embodiment, and the other line may be a straight line in parallel with the bisector 1a of the partition 13f.

In addition, according to the above-explained electrical connectors 10 of the first and second embodiments, first, the resin filled in the inlet of the die is caused to flow in the portion where the operation part 13a is to be molded to integrally mold the actuator 13. In order to do so, the wider-width part 13h, 13g is disposed between the one end of the partition 13f and the operation part 13a.

However, the present disclosure is not limited to this case. The portion where the wider-width part 13h, 13g is to be molded in the die is provided so as to guide the filler contained in the resin flowing into the portion where the partition 13f is to be molded.

Accordingly, when, for example, the inlet of the die is continuous with the portion where the shaft 13c is to be molded, the resin filled in the inlet first flows in the portion where the shaft 13c is to be molded, and eventually flows in the portion where the operation part 13a is to be molded. When the actuator 13 is integrally molded in this manner, the portion where the wider-width part 13g, 13h is to be molded is disposed between the portion where the shaft 13c is to be molded corresponding to the upstream side of the resin flow, and the portion where the partition 13f is to be molded.

Accordingly, the wider-width part 13g, 13h is disposed between the shaft 13c and the one end of the partition 13f coupled with the shaft 13c. The wider-width part 13g, 13h each includes a wider-width surface that increases the width toward the upstream side of the resin flow from the downstream side thereof (toward the shaft 13c from the one end of the partition 13f). The widths of the wider-width surfaces are Wb and Wc which are larger than the width Wa of the one end of the partition 13f.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SYMBOLS

10 Electrical connector, 11 Housing, 12 Contact, 12a First contact, 12b Second contact, 12a1, 12b1, 14a Upper beam, 12a2, 12b2, 14b Lower beam, 12a3, 12b3 Pillar, 12aa First contact part, 12ab First connection part, 12ba Second contact part, 12bb Second connection part, 13 Actuator, 13a Operation part, 13b Abutting part, 13c Shaft, 13d Axial center, 13e Through-hole, 13f Partition, 13g, 13h Wider-width part, 14 Locking, 15 Slot, 50 FPC, 51 Electrode, 51a First electrode, 51b Second electrode, 52 Cut-out, 80 Die, 81 Inlet, 1a Bisector, 1b, 1c Straight line, 1d, 1e Curved line

What is claimed is:

1. An electrical connector comprising:
an insulative housing that is formed with a slot in which a tabular signal transmission member is fittable;
a plurality of contacts each comprising an elastic conductor in a substantially H shape including a pair of beams and a pillar that connects the pair of beams with each other, the pair of beams located at one-end side with reference to the pillar being disposed in the slot of the housing so as to correspond to respective electrodes of the signal transmission member fitted in the housing through the slot; and
an actuator attached to the housing in a freely rotatable manner, including a shaft which is held between the pair of beams at an other-end side with reference to the pillar, and which is rotatable around an axial center along with the rotation of the actuator, and enabling the plurality of contacts to contact the electrodes upon rotation of the shaft,
wherein the actuator comprises:
a tabular partition that partitions, for each beam located at a position that allows the beam to abut the actuator, a through-hole into which one of the pair of beams located at the other-end side and at the position that allows the beam to abut the actuator is inserted to prevent the beam from abutting the actuator; and
a wider-width part including a wider-width surface which is disposed at one end of the partition corresponding to an upstream side of a flow of resin flowed to mold the partition when the actuator is molded by the resin containing a filler, and which has a wider width than a width of the one end of the partition.

2. The electrical connector according to claim 1, wherein:
the actuator further comprises an operation part to be rotated;
the one end of the partition is connected with the operation part; and
the wider-width part is disposed between the operation part corresponding to the upstream side of the resin flow and the one end of the partition.

3. The electrical connector according to claim 1, wherein:
the one end of the partition is connected with the shaft; and
the wider-width part is disposed between the shaft corresponding to the upstream side of the resin flow and the one end of the partition.

4. The electrical connector according to claim 1, wherein, among contour lines of the wider-width surface, two lines that couple the upstream side of the resin flow with the downstream side thereof are straight lines that increase the width of the wider-width surface toward the upstream side from the downstream side.

5. The electrical connector according to claim 1, wherein, among contour lines of the wider-width surface, two lines that couple the upstream side of the resin flow with the downstream side thereof are curved lines that increase the width of the wider-width surface toward the upstream side from the downstream side.

6. The electrical connector according to claim 4, wherein a maximum width of the wider-width surface is greater than a length of the filler contained in the resin that molds the actuator.

7. The electrical connector according to claim 5, wherein a maximum width of the wider-width surface is greater than a length of the filler contained in the resin that molds the actuator.
